(19) United States
(12) Patent Application Publication
(10) Pub. No.: US 2015/0047943 A1
(43) Pub. Date: Feb. 19, 2015

(54) SPIRAL SPLINES TAPERED WEIGHT CLUTCH

(71) Applicant: Gile Jun Yang Park, Burnaby (CA)

(72) Inventor: Gile Jun Yang Park, Burnaby (CA)

(21) Appl. No.: 14/076,035

(22) Filed: Nov. 8, 2013

(30) Foreign Application Priority Data
Aug. 16, 2013 (CA) 2821351

(51) Int. Cl. F16D 13/24

(52) U.S. Cl. CPC F16D 13/24
USPC 192/66.23

(57) ABSTRACT

A cone clutch having a male cone driven by a shaft transferring torque from a power source to a female cone, the male cone moveable along spiral splines on the shaft from a first position disengaged from said female cone to a second position engaged with the female cone, a spring located on said shaft between said male and female cones forcing the male cone towards the first position, the male cone forced to move towards the second position by the action of the spiral splines during rotation of the shaft.

### FIELD OF THE INVENTION

The present invention relates to a clutch and more particularly to a cone clutch having a male cone in the form of a spiral spline tapered weight moveable along a spiral spline covered shaft from a first disengaged position to a second position engaged with a female cone for transferring torque thereto. Movement of the male cone from the first position to the second position is caused by rotation of the shaft.

### BACKGROUND OF THE INVENTION

A cone clutch is a form of friction clutch. As opposed to the flat engaging surfaces of a disk clutch, the cone clutch has the friction surfaces arranged as a short section of a cone with the opposing parts moving axially to engage and disengage the drive. Cone clutches were commonly used in the early part of the 20^{th} century as they fit more friction surface into a given diameter. However, with advances in frictional materials, this added friction surface has no longer been required leading to their replacement by disk clutches.

Prior art cone clutches comprise a female cone, with a male cone forced into frictional engagement with the female cone by a spring. The cones are disengaged by way of a clutch control.

Objects of the invention will be apparent from the description that follows.

### SUMMARY OF THE INVENTION

The invention consists of cone clutch comprising a shaft extending from a power source and rotatable to transfer torque; a male cone mounted on said shaft; a female cone adapted to receive said male cone in frictional engagement, the male cone being moveable longitudinally along the shaft between a first position disengaged from the female cone and a second position frictionally engaged with the female cone; wherein when in the second position, the male cone transferring torque from the shaft to the female cone.

In another aspect, there is a spring mounted on said shaft and disposed between the male and female cones, forcing the two away from one another. The male cone moves to said second position when the shaft spins at sufficient rpm to apply sufficient force to said male cone to overcome the spring.

The foregoing was intended as a broad summary only and of only some of the aspects of the invention. It was not intended to define the limits or requirements of the invention. Other aspects of the invention will be appreciated by reference to the detailed description of the preferred embodiment and to the claims.

### BRIEF DESCRIPTION OF THE DRAWINGS

These and other features of the invention will become more apparent from the following description in which reference is made to the appended drawings and wherein:

FIG. 1 is an exploded perspective view of the preferred embodiment of a cone clutch according to the present invention.

FIG. 2 is a perspective view of the cone clutch shown in FIG. 1 with the male cone engaged in the female cone.

FIG. 3 is a perspective view of the cone clutch shown in FIG. 1 with the male cone disengaged from the female cone.

FIG. 4 is a partial cross-sectional perspective view of clutch shown in FIG. 2.

FIG. 5 is a partial cross-sectional perspective view of the clutch shown in FIG. 3.

### DESCRIPTION OF THE PREFERRED EMBODIMENTS

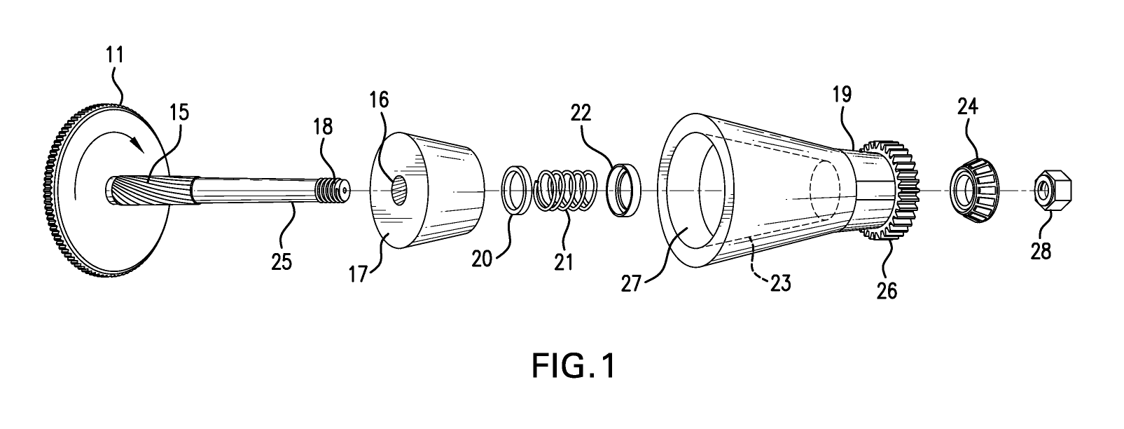

The preferred embodiment of a cone clutch according to the present invention is shown exploded in FIG. 1 so as to best illustrate the various elements. A motor fly wheel 11 having a shaft 25 extending therefrom, a portion of shaft 25 having spiral splines 15, is used to transmit torque from a power source such as an engine, whether it be combustion, pneumatic, hydraulic or electric. While a fly wheel has been shown in the preferred embodiment, it is not an essential feature of the invention; rather, it is the spiral spline covered shaft extending from a source of torque that is a necessary component of the invention. A male cone in the form of a tapered weight 17 having internal spiral splines 16 is threaded onto the spiral splines 15. Spiral splines 15 and 16 are angled and sized to allow mating engagement with one another. Shaft 25 terminates in a threaded portion 18.

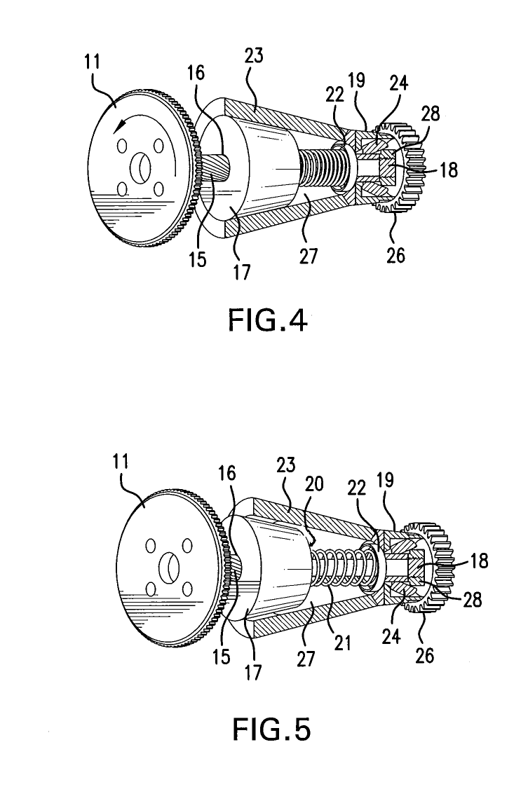

A female cone in the form of a tapered weight clutch drum 23 having an internal friction wall 27 is also mounted on shaft 25 and secured thereto by way of a thrust bearing 24 and a nut 28 which is fixedly connected to, and threaded onto, thread 18 on the end of shaft 25. The tapered outer wall of male cone 17 and the interior 27 of female cone 23 are sized and dimensioned to correspond to one another such that male cone 17 may be inserted into female cone 23 and become engaged in a friction fit. As shown in FIGS. 4 and 5 thrust bearing 24 is fitted within hub 19 of the tapered weight clutch Drum 23. Thrust bearing 24 allows shaft 25 to rotate freely therein, such that rotation of the shaft 25 has no direct impact on rotation of the female cone 23, but rather only through rotation of male cone 17.

A spring 21 is positioned on shaft 25 between the male cone 17 and female cone 23, preferably between a retainer cup 20 and a bearing 22. It is also contemplated that the male and female cones could have portions sized and shaped to receive either end of the spring such that no retainer cup/bearing is required. At least one of the spring receiving portions would be equipped with some form of bearing to prevent damage to the spring (ie. to prevent opposite ends of the spring from rotating at different rates and damaging the spring).

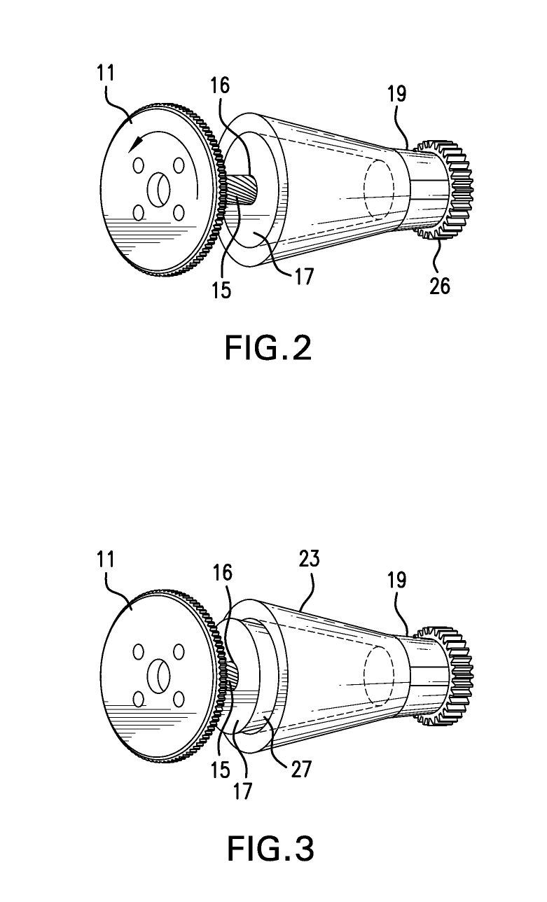

Male cone 17 has a first position disengaged from female cone 23 and a second position engaged with female cone 23. When assembled, spring 21 forces male cone 17 away from female cone 23 such that these two components are not in contact with each other (disengaged position), as shown in FIGS. 3 and 5. However, when shaft 25 rotates, it applies a force to male cone 17 by way of splines 15. In addition to being caused to rotate, male cone 17 moves longitudinally along the axis of shaft 25 towards female cone 23. When the rotation is sufficiently high, the force being exerted on the male cone in the longitudinal direction is sufficient to overcome the force being applied by the spring 21, and the male cone is forced into female cone 23 as shown in FIGS. 2 and 4 (engaged position). With sufficient force, the friction fit between the male and female cones is significant and the male cone 17 transmits torque from the spiral splines 15 (and shaft 25) to the female cone 23. The female cone is preferably equipped with a power output such as a gear 26 or pulley or the like. Alternatively, a further spline equipped shaft could be connected to the end of female cone 23 to connect to a further assembly for transferring power such as a transmission.

Selection of the spring 21 is based on the amount of rpm desired in order to cause engagement of the male cone 17 in female cone 23. For example, a spring may be selected which will force male cone 17 to remain separated from female cone 23 until the rpm reach 500 at which time the male cone 17 will be frictionly fitted within female cone 23 thereby transferring torque to it and through power output 26 to something to be driven. When the rpm drop below 500, or when the rate of rotation of female cone 23 is greater than that of the shaft 25, the male cone 17 will be forced to disengage.

Using a vehicle as an example, the cone clutch would provide a simplified process for a manual transmission. No clutch pedal would be required, with action of the clutch being controlled by the rpm of the engine and the speed of rotation of the wheels. For example, starting in first gear, a driver would apply the gas pedal providing power in the form of torque to shaft 25 which is transmitted through splines 15 to male cone 17. When the rpm are sufficiently high, male cone 17 engages with female cone 23 and power (torque) is transmitted through female cone 23 by way of power output 26 to other components (transmission, etc.) and to the wheels of the vehicle. When it is time to shift gears, the driver simply takes their foot off the gas pedal, with the resulting drop in rpm of the motor and shaft 25 causing male cone 17 to release from engagement with female cone 23. Once gears have been shifted, pushing down the gas pedal sufficiently will cause male cone 17 to reengage with female cone 23, once again directing power to the wheels. When a vehicle is going down a hill, a user could remove their foot from the gas pedal resulting in a reduction in the rpm being delivered to shaft 25 from the flywheel (and engine), while the female cone 23 would continue at higher rpm based on the speed of the vehicle, thereby causing the male cone 17 to disengage from female cone 23.

Preferably the male and female cones 17, 23 are made of metal. While the forcible engagement of the two make an added frictional material unnecessary, it is also contemplated that a friction material could be added to a metal surface, preferably to the interior of female cone 23. Over time, male cone 17 will reduce in diameter as a result of use and those portions of the interior 27 of female cone 23 being subject to use will increase in diameter. As this occurs, male cone 17 need simply travel slightly further longitudinally along splines 15 and further into female cone 23 until engaged in a friction fit with the interior surface 27.

While use of the clutch in a vehicle has been described, the cone clutch of the present invention could be used in power tools, such as an electric drill, or in other devices requiring a clutch having the functioning described above.

It will be appreciated by those skilled in the art that the preferred and alternative embodiments have been described in some detail but that certain modifications may be practiced without departing from the principles of the invention.

1. A cone clutch for transferring torque comprising:
a shaft extending from a power source and rotatable to transfer torque;
a male cone mounted on said shaft;
a female cone adapted to receive said male cone in frictional engagement, said female cone rotatably connected to said shaft via a thrust bearing and nut;
said male cone being moveable longitudinally along said shaft between a first position disengaged from said female cone and a second position frictionally engaged with said female cone;
a spring mounted on said shaft, said spring forcing said male cone towards said first position
wherein rotation of said shaft forcing said male cone towards said second position, and when in said second position, said male cone transferring torque from said shaft to said female cone.

2. The cone clutch of claim 1, wherein said shaft having external spiral splines.

3. The cone clutch of claim 2, wherein said male cone having internal spiral splines and a tapered outer surface, said male cone threaded onto said external spiral splines.

4. The cone clutch of claim 3, wherein said female cone having an internal tapered surface adapted for frictional engagement with said tapered outer surface of said male cone.

5. The cone clutch of claim 1 wherein said female cone being adapted to transfer torque from said shaft.

6. The cone clutch of claim 1 wherein said spring mounted on said shaft being disposed between said male cone and said female cone.

7. (canceled)

8. The cone clutch of claim 1 wherein said spring being compressed by said male cone at a pre-selected rpm of said shaft so as to allow said male cone to move to said second position.

9-11. (canceled)
